(19) United States
(12) Patent Application Publication
(10) Pub. No.: US 2011/0277602 A1
(43) Pub. Date: Nov. 17, 2011

(54) Chuck Mechanism, Pawl Material, and Lathe

(75) Inventor: Kazuhide Kobayasi, Chiba (JP)

(73) Assignee: Synthe Tech Inc., Ibaraki (JP)

(21) Appl. No.: 13/145,635

(22) PCT Filed: Jan. 21, 2009
(86) PCT No.: PCT/JP2009/050849

§ 371 Date: Jul. 21, 2011

(51) Int. Cl. B23B 31/10; B23B 3/06; B23B 31/16

(52) U.S. Cl. 82/117; 279/66; 279/152

(57) ABSTRACT

A chuck mechanism for grasping a work comprises a stage, a master jaw provided on the stage, and a soft jaw fixed to the master jaw, in which a plurality of serrations extending in two different directions are formed on the abutting surfaces of master and soft jaws, respectively. Since the serrations are fitted, there is no such a risk that the soft jaw is displaced in the direction of the surface abutting against the master jaw. Consequently, reproducibility of fixing of the soft jaw becomes very high and a chuck mechanism having a soft jaw having a high reproducibility of fixing thereof can be provided.

### TECHNICAL FIELD

The present invention relates to a chuck mechanism for gripping a workpiece and fixing the workpiece to a machine tool, a jaw member, and a lathe provided with the chuck mechanism.

### BACKGROUND ART

In general, a machine tool such as a lathe for cutting and processing a workpiece (work) principally includes a stage, a chuck mechanism which fixes the workpiece on the stage, and a spindle which rotates the stage at a high speed. For example, when an outer circumferential surface of a workpiece having a columnar shape is subjected to the cutting processing, an outer wall surface of the workpiece is gripped or clamped by the chuck mechanism to fix it to the stage. For example, PLT1 discloses a chuck for a machine tool having a main chuck body which has a cylindrical shape, three master jaws which are provided for the main chuck body at intervals of 120 degrees in the circumferential direction thereof and which are attached slidably movably in the radial direction of the main chuck body, and top jaws which are fixed to the respective master jaws and which grip the workpiece. The top jaws are fixed to the master jaws by means of bolts respectively. The top jaws are slidably movable in the radial direction of the main chuck body together with the master jaws by means of the pressure of the air or the like. The top jaws, which are fixed to the master jaws, are moved toward the center side in the radial direction, and the end surfaces of the top jaws, which are disposed on the center side, are allowed to abut against the outer circumferential surface of the workpiece so that the workpiece is gripped thereby.

In this situation, the center side end surfaces of the top jaws press the outer circumferential surface of the workpiece toward the center. Therefore, an extremely large force, which is directed outwardly in the radial direction, is consequently allowed to act as the reaction force thereof on the center side end surfaces of the top jaws. The reaction force acts as the force to push the top jaws fixed to the master jaws outwardly in the radial direction. Therefore, for example, if the master jaw and the top jaw are not fixed tightly, it is feared that the top jaw may be deviated outwardly in the radial direction by being overcome by the reaction force. In view of the above, in order to prevent the top jaws from being deviated outwardly in the radial direction, a plurality of sawtooth-shaped projections (serrations) are formed on the abutment surfaces on which the master jaws and the top jaws are allowed to mutually abut respectively. The respective sawtooth-shaped projections extend in the circumferential direction of the main chuck body. The top jaws and the master jaws are fixed in a state in which the serrations are fitted to one another. Therefore, there is no fear of the deviation of the top jaws in the radial direction which is the direction perpendicular to the direction (circumferential direction) in which the serrations extend.

### CITATION LIST

### Patent Literature

PLT1: Japanese Patent Application Laid-open No. 2000-288809;
PLT2: Japanese Utility Model Application Laid-open No. 59-93804;
PLT3: Japanese Utility Model Application Laid-open No. 05-16017.

### SUMMARY OF INVENTION

### Technical Problem

In order to accurately process or machine the workpiece, it is necessary that the center of rotation of the spindle and the center of the workpiece should be positioned at a sufficient accuracy, i.e., the workpiece should be subjected to the centering at a sufficiently high accuracy. In this procedure, the workpiece may be detached from the chuck for the machine tool during the processing of the workpiece. In such a situation, when the top jaw is detached from the master jaw, the following problem arises. That is, even when the same workpiece is gripped or clamped by using the same top jaw and the same master jaw, the center of the workpiece is deviated from the center of rotation of the spindle, for the following reason. In this case, the top jaw is fixed to the master jaw by means of the bolt. However, for example, when the bolt having a size of M16 is used, it is prescribed by the standard that the outer diameter of the bolt should be manufactured at a tolerance of −20 μm, and the inner diameter of the bolt hole should be formed at a tolerance of +20 μm. Therefore, there is such a possibility that any deviation may arise within the tolerances when the top jaw is fixed to the master jaw by means of the bolt. However, as described above, the serrations, which extend in the circumferential direction, are formed on the abutment surfaces of the top jaw and the master jaw respectively, and they are fitted to one another. Therefore, there is no fear of the deviation of the top jaw in the radial direction. However, a problem arises in relation to the circumferential direction such that the deviation occurs within the range of the tolerance as described above. A soft jaw for a lathe chuck, which is described in PLT2, comprises an attachment section for the soft jaw for the lathe chuck which is formed with surface projecting stripes allowed to extend in one direction, and the soft jaw which is formed with grooves to be fitted to the surface projecting stripes. In this case, the grooves, which are formed on the soft jaw, include grooves which extend in a plurality of directions. The soft jaw can be fixed in any direction of the plurality of directions. In other words, the soft jaw can be fixed to the soft jaw attachment section while rotating the soft jaw. Therefore, it is possible to form a large number of end surfaces for gripping the workpiece by the soft jaw. Also in the case of the lathe chuck as described above, a problem arises such that the deviation occurs within the range of the tolerance as described above in the direction in which the surface projecting stripes of the soft jaw attachment section are allowed to extend, when the soft jaw is attached in the same manner as described above.

In order to avoid the problems as described above, a chuck, which comprises a primary jaw and a secondary jaw in place of the top jaw of the chuck for the machine tool described above, is disclosed in PLT3, as a chuck in which the reproducibility is high for the centering of the workpiece when the workpiece is attached again after the workpiece or the like is once detached. In this case, the primary jaw has a substantially sectoral shape, which is fixed to a master jaw by means of the bolt. The secondary jaws are attached to the both side surfaces of the primary jaw in the radial direction respectively. In this arrangement, a plurality of serrations, which extend in the direction perpendicular to the radial direction, are formed on the abutment surfaces of the primary jaw and the secondary jaw on which the primary jaw and the secondary jaw are allowed to mutually abut respectively. The secondary jaws are fixed to the primary jaw in a state in which they are fitted to one another.

When the workpiece is gripped, then the primary jaw is fixed to the master jaw in a state in which the secondary jaws are attached to the primary jaw, and the primary jaw is air-driven toward the center in the radial direction together with the master jaw. The surfaces of the secondary jaws, which are disposed on the side of the center in the radial direction, are allowed to abut against the outer circumferential surface of the workpiece so that the workpiece is held thereby. Even when the secondary jaws are detached when the workpiece is detached, the reproducibility is maintained when the workpiece is subjected to the centering again, on condition that the primary jaw is not detached from the master jaw, for the following reason. That is, the serration processing is applied as described above to the abutment surfaces of the secondary jaw and the primary jaw. Therefore, the reproducibility is extremely high for the positioning of the secondary jaw in the radial direction. Further, there is no fear of the deviation of the position of the secondary jaw in the circumferential direction unless the primary jaw is detached.

However, in the case of the chuck which adopts the primary and secondary jaws as described above, when the primary jaw is once detached from the master jaw, the reproducibility disappears for the centering of the workpiece. Therefore, it is necessary that the primary jaw should be always attached to the master jaw. Further, when the primary jaw is always attached to the lathe, an inconvenience arises such that the lathe cannot be utilized in any other way of use. Further, the primary jaw and the secondary jaw are required, and hence the weight of the chuck is increased. It is impossible to raise the number of revolutions of the spindle during the processing. Further, the number of parts of the chuck is increased. Therefore, a long period of time is required for the procedure setting including, for example, the adjustment for the attachment of the chuck, and a long period of time is required for the parts exchange. A problem also arises such that the working time cannot be shortened.

An object of the present invention is to provide a chuck mechanism which requires a small number of parts, which makes it possible to perform the centering for a workpiece at a high accuracy, and which provides the high reproducibility of the centering, a jaw member, and a lathe which is provided with such a chuck mechanism.

### Solution to Problem

According to a first aspect of the present invention, there is provided a chuck mechanism which grips a workpiece, including:

a stage which is rotatable about a center of a predetermined axis of rotation;

a plurality of master jaws which are provided on the stage, the master jaws being movable in directions directed toward the axis of rotation of the stage and each of the master jaws having a master side serration surface formed with a plurality of first serrations extending in a first direction and a plurality of second serrations extending in a second direction different from the first direction; and

a plurality of soft jaws which are fixed to the master side serration surfaces of the master jaws to grip the workpiece, respectively, each of the soft jaws having a soft side serration surface arranged to face the master side serration surface and formed with third serrations and fourth serrations, the third serrations extending in the first direction to be fitted to the first serrations, and the fourth serrations extending in the second direction to be fitted to the second serrations.

According to the chuck mechanism of the present invention, the plurality of first serrations and the plurality of second serrations, which extend in the two different directions respectively, are formed on the serration surface of the master jaw. The third and fourth serrations, which extend in the two different directions respectively and which are fitted to the first and second serrations respectively, are formed on the serration surface of the soft jaw. Therefore, when the soft jaw is fixed to the master jaw while allowing the serration surface of the master jaw and the serration surface of the soft jaw to be opposed to one another, there is no fear of any deviation of the soft jaw in the in-plane direction of the serration surface of the master jaw. Therefore, it is possible to enhance the attachment accuracy when the soft jaw is attached to the master jaw. Further, the attachment reproducibility is extremely enhanced as well.

In the chuck mechanism of the present invention, the first direction may be perpendicular to the second direction. In this arrangement, the two types of the serrations, which are formed on the master jaw and the soft jaw respectively, extend in the mutually perpendicular directions. Therefore, the deviation of the soft jaw is suppressed in relation to the two perpendicular directions. Therefore, there is no fear of the deviation of the soft jaw in the in-plane direction of the serration surface of the master jaw (in any arbitrary direction in the serration surface). The attachment reproducibility is improved for the soft jaw.

In the chuck mechanism of the present invention, the soft side serration surface of each of the soft jaws may have a first area in which the third serrations are formed and a second area which is formed to be independent from the first area and in which the fourth serrations are formed. In this arrangement, the areas, in which the serrations allowed to extend in the two different directions are formed, are independently formed on the serration surface of the soft jaw. Therefore, the positional deviation is suppressed in any direction different from the directions in which the serrations formed in the areas are allowed to extend, in the respective areas. Therefore, there is no fear of the deviation of the soft jaw in the in-plane direction of the serration surface of the master jaw (in any arbitrary direction in the serration surface) as a whole. The attachment reproducibility is improved for the soft jaw.

In the chuck mechanism of the present invention, the first serrations and the second serrations may be formed in a same area on the master side serration surface of each of the master jaws. In this arrangement, the two types of the serrations, which are allowed to extend in the two different directions, are formed in the same area on the master side serration surface. Therefore, the serrations can be fitted to any one of the two types of the serrations formed on the soft jaw in the concerning area. Therefore, the degree of freedom is improved for the arrangement of the soft jaw on the serration surface of the master jaw. For example, the soft jaw can be also arranged in the opposite direction while inverting the soft jaw by 180 degrees.

In the chuck mechanism of the present invention, a plurality of substantially quadrangular pyramid-shaped spikes, which are arranged in a lattice form in the first direction and the second direction respectively and which have chamfered forward ends, may be formed on the master side serration surface of each of the master jaws. In this arrangement, the plurality of quadrangular pyramid-shaped spikes, which are arranged in the lattice form in the first direction and the second direction, are formed on the serration surface of the master jaw, and hence the spikes can be fitted to any one of the two types of the serrations allowed to extend in the first and second directions of the soft jaw. Therefore, the degree of freedom is improved for the arrangement of the soft jaw on the serration surface of the master jaw. Further, the forward ends (tips or apexes) of the respective spikes are chamfered. Therefore, when the spikes are fitted to the respective serrations of the soft jaw, there is no fear for the forward ends to abut against the valleys of the serrations of the soft jaw. The inclined surfaces of the spikes and the inclined surfaces of the serrations can be reliably subjected to the surface-to-surface contact. It is possible to improve the attachment reproducibility of the soft jaw.

In the chuck mechanism of the present invention, the third and fourth serrations, which are formed on the soft side serration surface of the soft jaw, may be a plurality of stripe-shaped sawteeth which have substantially triangular cross sections and which have chamfered forward ends. In this arrangement, the third and fourth serrations can be manufactured with ease by using, for example, a serration cutter, because the third and fourth serrations are the stripe-shaped sawteeth having the substantially triangular cross sections. Further, the forward ends (tips or apexes) are chamfered, and hence there is no fear for the forward ends to abut against the valleys of the serrations of the master jaw, when the third and fourth serrations are fitted to the serrations of the master jaw. The inclined surfaces of the concerning sawteeth and the inclined surfaces of the serrations of the master jaw can be reliably subjected to the surface-to-surface contact. It is possible to improve the attachment reproducibility of the soft jaw.

In the chuck mechanism of the present invention, the stage may have a fixed stage which is substantially circular, and a plurality of movable stages which are provided movably in a radial direction of the fixed stage and which are formed with a plurality of grooves into which the master jaws are to be inserted; and the plurality of master jaws may be fixed to inner portions of the grooves of the movable stages respectively. In this arrangement, the master jaws are fixed to the movable stages, and hence the master jaws can be also moved in the radial direction of the fixed stage together with the movable stages.

The chuck mechanism of the present invention may further include a plurality of connecting members which connect the master jaws and the soft jaws respectively, and grooves into which the connecting members are to be inserted may be formed for the respective master jaws. In this arrangement, the chuck mechanism has the connecting members for connecting the master jaws and the soft jaws, and hence the soft jaws can be reliably connected to the master jaws. Further, the master jaws are formed with the grooves for inserting the connecting members thereinto. Therefore, it is easy to position the connecting members, and the time and labor, which are required when the soft jaws are fixed to the master jaws, are mitigated.

In the chuck mechanism of the present invention, the connecting member may have a substantially T-shaped cross-sectional shape, and may include a head which is plate-shaped and a leg which has a width narrower than that of the head and which is allowed to extend perpendicularly to an in-plane direction of the head; and the groove, which is formed in the master jaw, may have a substantially T-shaped cross-sectional shape formed with a bottom portion which has a width wider than the width of the head and an upper portion which has a width narrower than the width of the head and wider than the width of the leg. In this arrangement, the width of the upper portion of the groove formed for the master jaw is narrower than the width of the head of the connecting member. Therefore, when the connecting member is inserted into the groove formed for the master jaw, there is no fear of any disengagement of the connecting member in the depth direction of the groove.

In the chuck mechanism of the present invention, a groove, which is to be fitted to the leg of the connecting member, may be formed on the soft side serration surface of each of the soft jaws. Further, a length, of the connecting members, in a depth direction of the grooves may be shorter than a depth of the grooves. In any case, the leg of the connecting member is prevented from any abutment against the soft jaw. It is possible to reliably connect the soft jaws and the master jaws.

According to a second aspect of the present invention, there is provided a lathe including the chuck mechanism of the present invention. According to the lathe of the present invention, when the soft jaws are exchanged in response to the workpiece for the chuck of the present invention, it is possible to perform the centering of the workpiece easily and quickly.

According to a third aspect of the present invention, there is provided a jaw member usable for a chuck mechanism which grips a workpiece, the jaw member including:

a plurality of master jaws each of which has a master side serration surface formed with a plurality of first serrations extending in a first direction and a plurality of second serrations extending in a second direction different from the first direction; and

a plurality of soft jaws which are fixed to the master side serration surfaces of the master jaws respectively to grip the workpiece, each of the soft jaws having a soft side serration surface arranged to face the master side serration surface and formed with third serrations and fourth serrations, the third serrations extending in the first direction to be fitted to the first serrations, and the fourth serrations extending in the second direction to be fitted to the second serrations.

According to the jaw member of the present invention, the plurality of first serrations and the plurality of second serrations, which extend in the two different directions respectively, are formed on the serration surface of the master jaw. The third and fourth serrations, which extend in the two different directions respectively and which are fitted to the first and second serrations respectively, are formed on the serration surface of the soft jaw. Therefore, when the soft jaw is fixed to the master jaw while allowing the serration surface of the master jaw and the serration surface of the soft jaw to be opposed to one another, there is no fear of any deviation of the soft jaw in the in-plane direction of the serration surface of the master jaw. Therefore, it is possible to enhance the attachment accuracy when the soft jaw is attached to the master jaw. Further, the attachment reproducibility is extremely enhanced as well.

In the jaw member of the present invention, the first direction may be perpendicular to the second direction. In this arrangement, the two types of the serrations, which are formed on the master jaw and the soft jaw respectively, extend in the mutually perpendicular directions. Therefore, the deviation of the soft jaw is suppressed in relation to the two perpendicular directions. Therefore, there is no fear of the deviation of the soft jaw in the in-plane direction of the serration surface of the master jaw. The attachment reproducibility is improved for the soft jaw.

In the jaw member of the present invention, the first and second serrations, which are formed on the master side serration surface of each of the master jaws, may include a plurality of substantially quadrangular pyramid-shaped spikes which are arranged in a lattice form in the first direction and the second direction respectively and which have chamfered forward ends; and

the third and fourth serrations, which are formed on the soft side serration surface of the soft jaw, may be a plurality of stripe-shaped sawteeth which have substantially triangular cross sections and which have chamfered forward ends.

In this arrangement, the spikes, which are formed on the master jaw, can be fitted to any one of the stripe-shaped sawteeth which are the third and fourth serrations of the soft jaw. Therefore, the degree of freedom is improved for the arrangement of the soft jaw. Further, the forward ends of the respective spikes and the sawteeth are chamfered respectively. Therefore, there is no fear of any interference of the forward ends when they are fitted to one another. The inclined surfaces of the respective spikes and the respective sawteeth can be reliably subjected to the surface-to-surface contact respectively. It is possible to improve the reproducibility of the attachment of the soft jaw.

### Advantageous Effects of Invention

When the master jaws and the soft jaws concerning the chuck mechanism of the present invention are utilized, it is possible to realize the chuck mechanism having a small number of parts. Therefore, it is possible to realize a light weight of the chuck mechanism, and it is possible to raise the number of revolutions of the spindle when the workpiece is processed.

### BRIEF DESCRIPTION OF DRAWINGS

FIG. 1 schematically shows a lathe according to an embodiment of the present invention.

FIG. 2 schematically shows a chuck mechanism of the present invention.

FIG. 3 schematically shows a soft jaw, a master jaw, and a fixing member of the chuck mechanism of the present invention.

FIG. 4 schematically shows the soft jaw according to the embodiment of the present invention.

FIG. 5 shows a plan view illustrating serration surfaces of the soft jaw according to the embodiment of the present invention.

FIG. 6 shows a side view illustrating the soft jaw according to the embodiment of the present invention.

FIG. 7 schematically shows the master jaw according to the embodiment of the present invention.

FIG. 8 schematically shows the soft jaw and the master jaw fitted to one another.

FIG. 9A shows a plan view illustrating a workpiece having a cylindrical shape according to the embodiment of the present invention, and FIG. 9B shows a sectional view illustrating the workpiece.

FIG. 10 schematically shows a state in which the workpiece is gripped by the chuck mechanism according to the embodiment of the present invention.

FIG. 11 shows a modified embodiment of the soft jaw according to the embodiment of the present invention.

FIG. 12 shows another modified embodiment of the soft jaw according to the embodiment of the present invention.

FIG. 13 shows a modified embodiment of the master jaw according to the embodiment of the present invention.

### REFERENCE SIGNS LIST

1: chuck mechanism, 12: stage, 13: fixed stage, 14: movable stage, 50: master jaw, 60: soft jaw, 80: workpiece.

### DESCRIPTION OF EMBODIMENTS

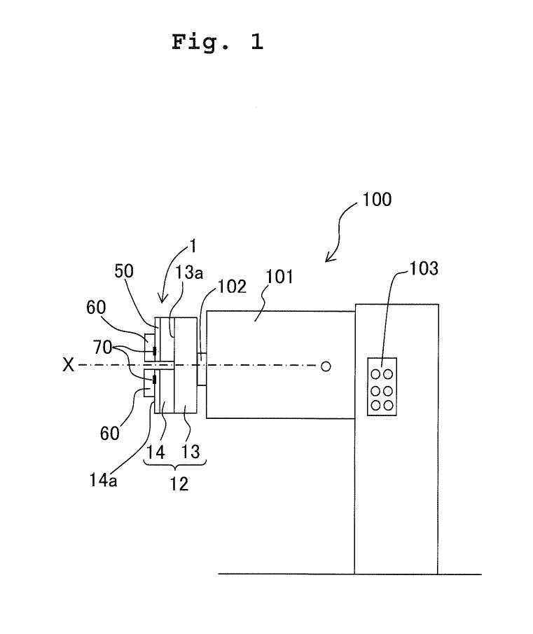

The chuck mechanism of the present invention will be explained below with reference to the drawings. A lathe 100 shown in FIG. 1 comprises a chuck mechanism 1 which grips or clamps a workpiece (work) to be processed, a motor (driving source) 101 which drives and rotates the chuck mechanism 1, a shaft (spindle) 102 which transmits, to the chuck mechanism 1, the rotary power generated by the motor 101 in cooperation with the rotary shaft of the motor 101, and a control unit 103 which controls the operation of the motor 101. For example, the direction of rotation and the speed of rotation of the motor 103 are adjusted on the basis of the instruction supplied from the control unit 103.

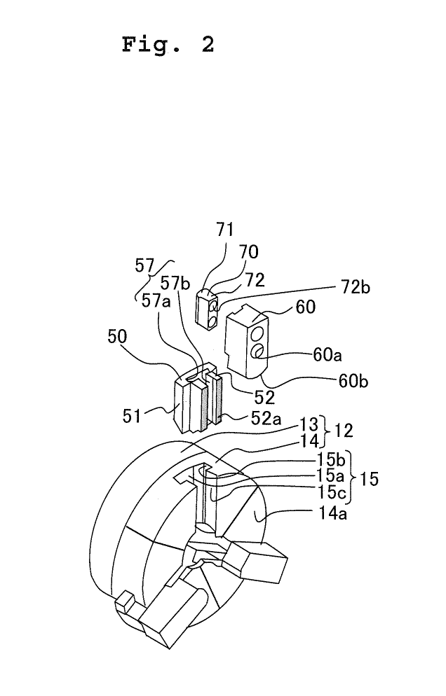

As shown in FIGS. 1 and 2, the chuck mechanism 1 includes a substantially cylindrical stage 12 which is provided rotatably with respect to the shaft 102, three master jaws 50 which are attached at intervals of about 120 degrees in the circumferential direction of the stage 12, three soft jaws (soft jaw members) 60 which are fixed to the respective master jaws 50, and fixing members (connecting members) 70 which fix the soft jaws 60 to the master jaws 50.

The stage 12 is provided with a fixed stage 13 which has a substantially cylindrical shape, and three movable stages 14 which are provided on the fixed stage. The central axis X of the fixed stage 13 is coincident with the direction in which the shaft 102 extends. The fixed stage 13 is fixed to the shaft 102 coaxially and rotatably. That is, the central axis X of the stage 12 and the axes of rotation of the shaft 102 and the fixed stage 13 exist coaxially. The three movable stages 14 are provided on an end surface 13a of the fixed stage 13 disposed on the side opposite to the shaft 102 so that the three movable stages 14 are movable (slidable) in the radial direction of the fixed stage 13. Each of the movable stages 14 has a substantially arch-shaped form with a central angle of about 120°, i.e., a sectoral shape as obtained by approximately equally dividing a doughnut-shaped disk with a penetrating hollow central portion into three. The respective movable stages 14 are provided at approximately equal intervals in a circumferential form about the center of the central axis X of the fixed stage 13. The movable stages 14 are driven in the radial direction of the fixed stage 13 by means of an unillustrated driving mechanism. An end surface 14a of each of the movable stages 14, which is disposed on the side opposite to the fixed stage 13, is formed to be a flat surface. The movable stages 14 can be positioned highly accurately with respect to the fixed stage 13. For example, when the movable stage 14, which has been at a predetermined radial position, is moved outwardly in the radial direction, and the movable stage 14 is thereafter returned to the predetermined position again by moving the movable stage 14 toward the center in the radial direction, then the positional deviation can be suppressed to be not more than 1 micron.

A groove 15, which is formed to attach the master jaw 50, is provided on the end surface 14a of each of the movable stages 14. The groove 15 extends in the radial direction of the movable stage 14. The groove 15 is composed of two spaces (bottom portion 15a and upper portion 15b) having different widths in the depth direction thereof. The width of the bottom portion 15a is larger than the width of the upper portion 15b. Accordingly, the cross-sectional shape of the groove 15 is substantially T-shaped. Although not shown, a screw hole (not shown), which is provided to fix the master jaw 50 by means of a bolt, is formed for a bottom surface 15c of the groove 15.

The master jaw 50 is a metal member extending in one direction (length direction), and the cross-sectional shape thereof is substantially T-shaped. In other words, the master jaw 50 has a base section 51 which is plate-shaped, and a main body section 52 which protrudes in the thickness direction perpendicularly to the surface of the base section 51 and which has the width narrower than that of the base section 51. The master jaw 50 is inserted into the groove 15 in a state in which the base section 51 and the main body section 52 are fitted to the bottom portion 15a and the upper portion 15b of the groove 15 formed for the movable stage 14 respectively. In this arrangement, the width of the bottom portion 15a of the groove 15 is slightly larger than the width of the base section 51 of the master jaw 50. On the contrary, the width of the upper portion 15b of the groove 15 is slightly larger than the width of the main body section 52, but the width of the upper portion 15b of the groove 15 is smaller than the width of the base section 51 of the master jaw 50. Therefore, the master jaw 50, which has been inserted into the groove 15 in the extending direction of the groove 15, cannot be extracted or disengaged in the depth direction of the groove 15, i.e., perpendicularly to the end surface 14a of the movable stage 14. An unillustrated bolt hole is formed for the base section 51. The master jaw 50 is fixed to the groove 15 of the movable stage 14 by means of the bolt in a state of being allowed to correspond to the screw hole formed for the bottom surface 15c of the groove 15 described above.

Serrations 55 are formed on surfaces (top surfaces, serration surfaces, master side serration surfaces) 52a disposed on the side opposite to the base section 51, of the main body section 52 of the master jaw 50 as described later on. A groove 57, which extends in the length direction of the main body section 52, is formed for the main body section 52. The groove 57 is composed of two spaces (bottom portion 57a and upper portion 57b) having different widths in the depth direction thereof. The width of the bottom portion 57a is larger than the width of the upper portion 57b. Accordingly, the cross-sectional shape of the groove 57 is substantially T-shaped.

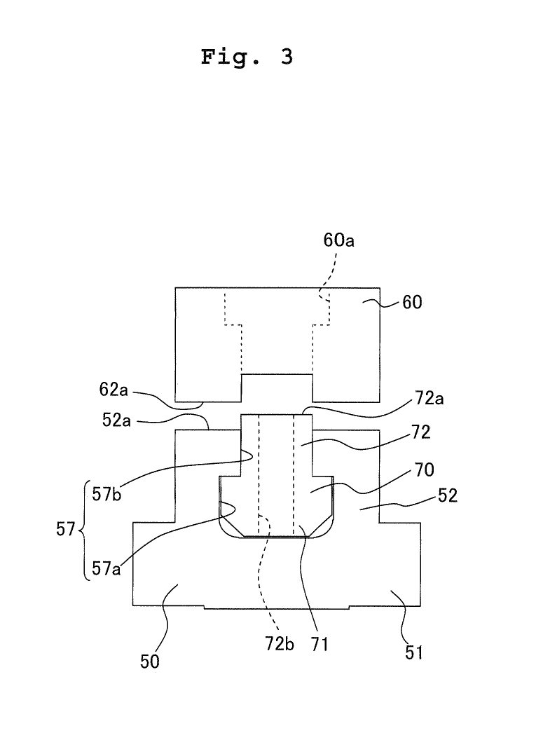

As shown in FIG. 3, a fixing member 70 is inserted into the groove 57 of the main body section 52. The fixing member 70 is a metal member extending in one direction (length direction), and the cross-sectional shape thereof is substantially T-shaped. In other words, the fixing member 70 has a head 71 which is plate-shaped, and a leg 72 which extends from the head 71 in the direction (thickness direction) perpendicular to the in-plane direction and which has the width narrower than that of the head 71. The fixing member 70 is inserted into the groove 57 in the length direction of the groove 57 in a state in which the head 71 and the leg 72 are fitted to the bottom portion 57a and the upper portion 57b of the groove 57 formed for the main body section 52 of the master jaw 50 respectively. There is no fear of the disengagement of the fixing member 70 having been inserted into the groove 57 in the depth direction of the groove 57, because the width of the head 71 of the fixing member 70 is larger than the width of the upper portion 57b of the groove 57, in the same manner as in the case in which the master jaw 50 is inserted into the groove 15 of the movable stage 14. When the fixing member 70 is inserted into the groove 57, the top surface 72a of the leg 72 is allowed to protrude as compared with the serration surface 52a of the master jaw 50. Screw holes 72b, which are formed to fix the soft jaw 60 by means of bolts, are formed for the leg 72 of the fixing member 70.

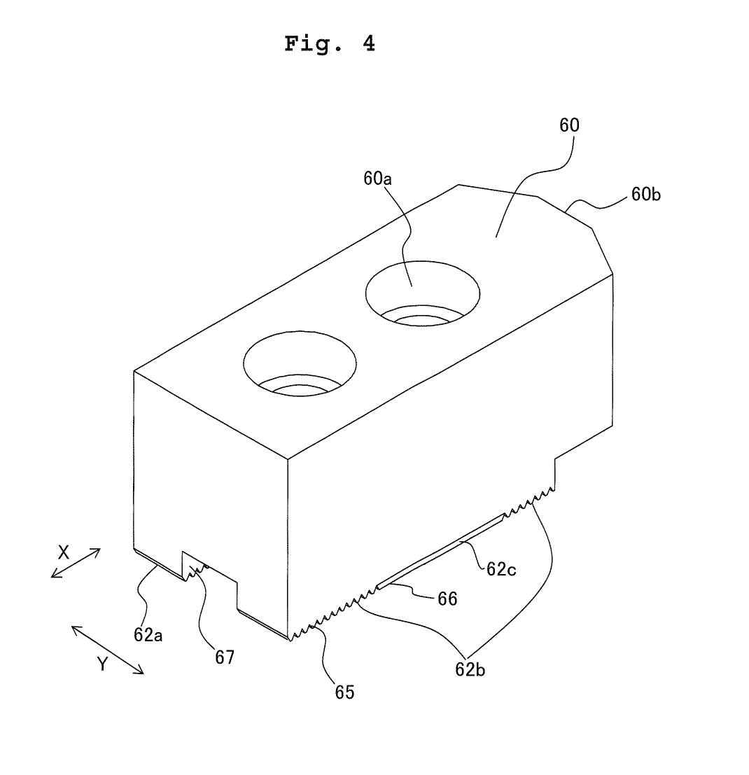

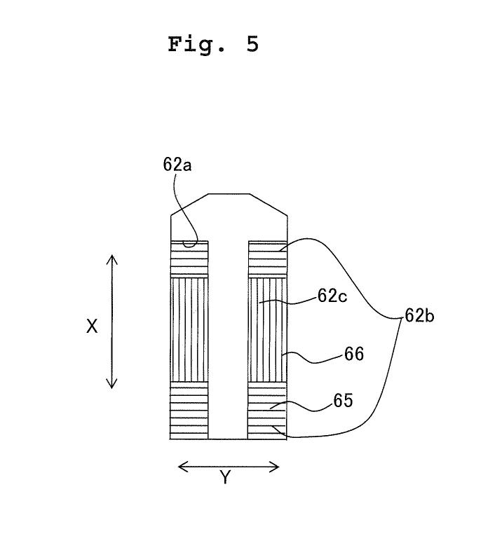

The soft jaw 60 is a metal member (for example, carbon steel material or the like such as S45C steel) which is substantially a rectangular parallelepiped that is long in one direction (length direction). The soft jaw 60 is formed with bolt holes 60a for fixing the soft jaw 60 to the fixing member 70 by means of the bolts. As shown in FIGS. 4 and 5, a plurality of serrations 65, 66 are formed on surfaces (top surfaces, serration surfaces, soft side serration surfaces) 62a of the soft jaw 60 which abut against the serration surfaces 52a of the master jaw 50 as described later on. Further, a groove 67, which extends in the length direction, is formed for the serration surfaces 62a of the soft jaw 60. The width of the groove 67 is approximately the same as the width of the upper portion 57a of the groove 57 of the master jaw 50. The groove 67 prevents the leg 72 of the fixing member 70 from making any abutment against the soft jaw 60, when the soft jaw 60 is fixed to the master jaw 50 by using the fixing member 70 as described later on.

Next, an explanation will be made about the serrations 55 formed on the serration surface 52a of the master jaw 50 and the serrations 65, 66 formed on the serration surface 62a of the soft jaw 60. The serration surface 62a of the soft jaw 60 has two first areas 62b which are arranged on the sides of the both ends in the length direction (in the X direction as shown in FIGS. 4 and 5), and a second area 62c which is interposed between the first areas 62b. The serrations 65 (fourth serrations), which extend in the widthwise direction of the soft jaw 60 (in the Y direction as shown in FIGS. 4 and 5), are formed in the first areas 62b. The serrations 66 (third serrations), which extend in the length direction of the soft jaw 60, are formed in the second area 62c.

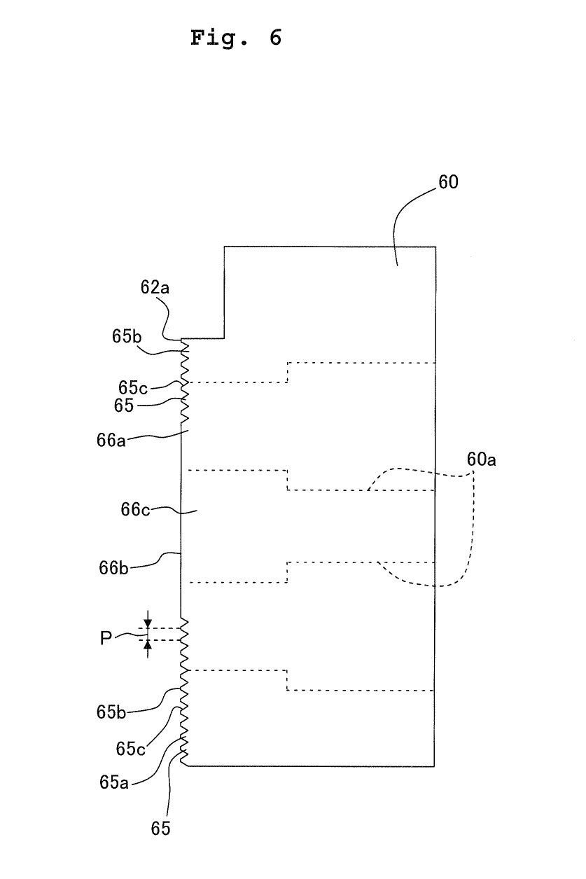

As shown in FIG. 6, the serration 65 has a plurality of stripe-shaped sawteeth 65a which are long in the widthwise direction and which protrude in the direction perpendicular to the serration surface 62a.

The sawteeth 65a are aligned in the length direction at predetermined pitches P (3 mm). The cross-sectional shapes of the respective sawteeth 65a are substantially regular or equilateral triangles. Each of the sawteeth 65a has a forward end 65b (forward end in the direction perpendicular to the serration surface 62a) which is subjected to the chamfering processing, and two inclined surfaces 65c which are inclined from the forward end 65b. The serration 66 also has a plurality of sawteeth 66a which have the same or equivalent shapes as those of the sawtooth 65a and which extend in the length direction. The sawteeth 66a are aligned in the widthwise direction at predetermined pitches P (3 mm). The plurality of sawteeth 65a, 66a, which extend in the predetermined directions and which are aligned at the predetermined pitches as described above, can be formed, for example, by applying the serration processing to the first and second areas 62b, 62c of the serration surface 62a respectively by using a serration cutter.

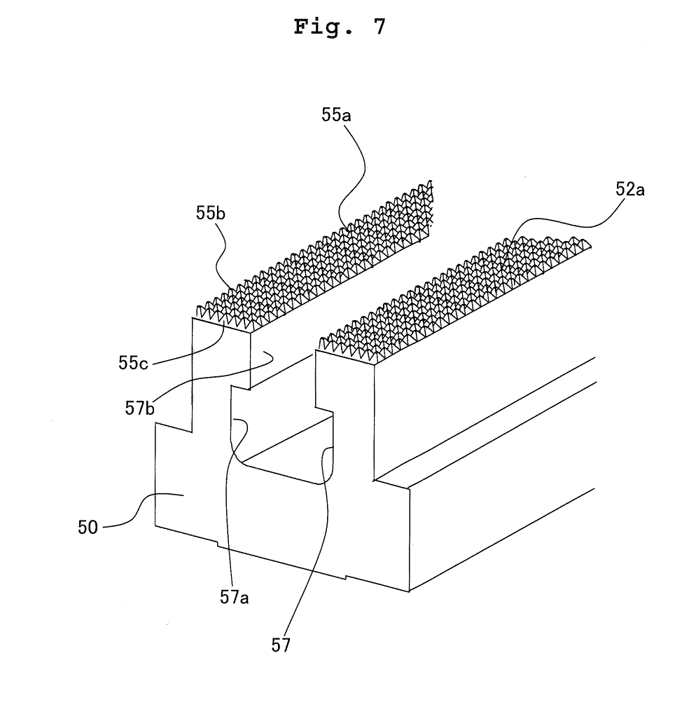

As shown in FIG. 7, the serration 55, which is formed on the serration surface 52a of the master jaw 50, has a plurality of quadrangular pyramid-shaped spikes 55a. The spikes 55a are arranged while being aligned at predetermined pitches P (3 mm) respectively in the length direction and the widthwise direction of the master jaw 50. The cross-sectional shape of each of the spikes 55a is substantially triangular. Each of the spikes 55a has a forward end 55b which is subjected to the chamfering processing, and four inclined surfaces 55c which are inclined from the forward end 55b. The spikes 55a can be manufactured, for example, by using a serration cutter such that a plurality of sawteeth, which extend in the predetermined direction and which are aligned at the predetermined pitches, are formed on the serration surface 52a, and a plurality of sawteeth, which extend in the direction perpendicular to the predetermined direction and which are aligned at the predetermined pitches, are further formed in the same area. That is, the serrations 55b (first serrations) extending in the length direction of the master jaw 50 and the serrations 55c (second serrations) extending in the widthwise direction are formed in the same area on the serration surface 52a of the master jaw 50. Accordingly, the serrations are allowed to intersect with each other so that the lattice-shaped spikes 55a are formed.

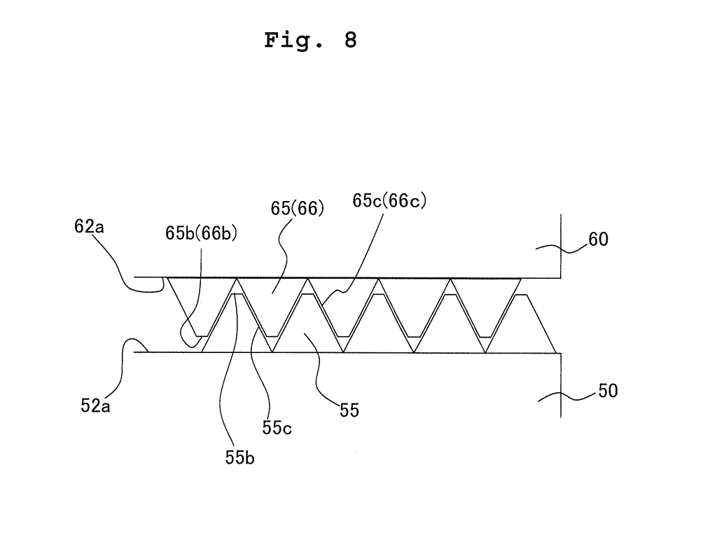

Next, an explanation will be made about a case in which the serration surface 52a of the master jaw 50 is allowed to abut against the serration surface 62a of the soft jaw 60. As shown in FIG. 8, when the serration surface 52a of the master jaw 50 is allowed to abut against the serration surface 62a of the soft jaw 60 in a state in which the length direction of the master jaw 50 is coincident with the length direction of the soft jaw 60, the serrations 55 and the serrations 65, 66 are fitted to one another. Specifically, the inclined surfaces 55c of the spikes 55a abut against the inclined surfaces 65c of the sawteeth 65a of the serrations 65. Similarly, the inclined surfaces 55c of the spikes 55a abut against the inclined surfaces 66c of the sawteeth 66a. In this arrangement, the chamfering processing is applied to the forward ends 55b of the spikes 55a and the forward ends 65b, 66b of the sawteeth 65a, 66a respectively. Therefore, the forward ends 55b, 65b, 66b do not abut against the opposing serration surfaces 62a, 52a. The inclined surfaces 55c of the spikes 55a and the inclined surfaces 65c, 66c of the sawteeth 65a, 66a can be subjected to the surface-to-surface contact.

In this arrangement, the pitches, at which the spikes 55a formed on the serration surface 52a of the master jaw 50 are aligned, are the same as the pitches at which the sawteeth 65a, 66a are aligned. Further, the spikes 55a are aligned in the widthwise direction and the length direction of the master jaw 50 respectively corresponding to the directions in which the sawteeth 65a, 66a are allowed to extend. Therefore, the spikes 55a, which are formed on the serration surface 52a of the master jaw 50, are fitted to the sawteeth 65a which are formed in the first areas 62b of the serration surface 62a of the soft jaw 60, and the spikes 55a are also fitted to the sawteeth 66a which are formed in the second area 62c. Therefore, the soft jaw 60 can be also used while being inverted by 180 degrees in relation to the length direction.

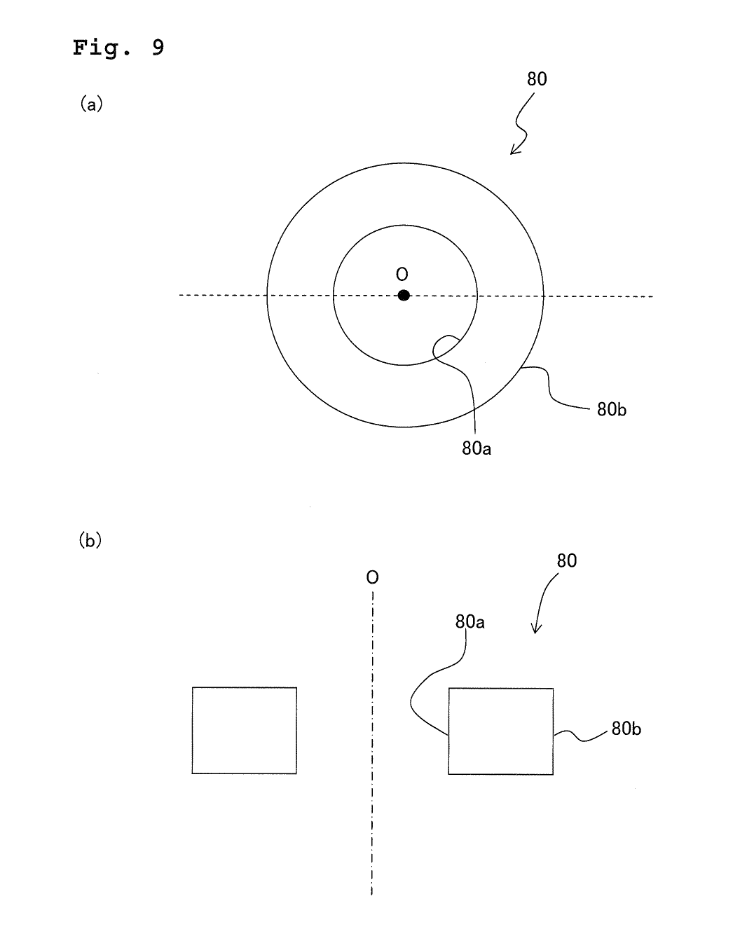

Next, an explanation will be made below about a procedure in which an inner cylindrical surface 80a of a cylindrical workpiece 80 is processed by using the lathe 100 provided with the chuck mechanism 1 described above. As shown in FIG. 9, the workpiece 80 is a substantially cylindrical metal member having the inner cylindrical surface 80a and an outer cylindrical surface 80b. The outer diameter and the inner diameter are 300 mm and 200 mm respectively, and the height of the cylinder is 200 mm.

At first, the chuck mechanism 1 is attached to the movable stages 14. Specifically, the three movable stages 14 are firstly driven to position them, for example, at predetermined radial positions such as positions most deviated toward the center. Subsequently, as shown in FIG. 2, the master jaws 50 are inserted into the grooves 15 formed for the movable stages 14, and the master jaws 50 are fixed by means of the bolts. Subsequently, the fixing members 70 are inserted into the grooves 57 formed for the main body sections 52 of the master jaws 50. Further, the serration surfaces 52a of the master jaws 50 and the serration surfaces 62a of the soft jaws 60 are opposed to one another, and the bolts are inserted into the bolt holes 60a of the soft jaws 60 to fix them to the fixing members 70. That is, the soft jaws 60 and the fixing members 70 are tightened by the bolts, followed by being further tightened in a state in which the main body sections 52 of the master jaws 50 are interposed between the heads 71 of the fixing members 70 and the serration surfaces 62a of the soft jaws 60. Accordingly, the soft jaws 60 are fixed to the master jaws 50.

As shown in FIGS. 4 to 6, the serrations 65, which extend in the widthwise direction of the soft jaw 60 (corresponding to the circumferential direction of the movable stage), are formed in the first areas 62b of the serration surface 62a of the soft jaw 60. The serrations 66, which extend in the length direction of the soft jaw 60 (corresponding to the radial direction of the movable stage), are formed in the second area 62c. In this arrangement, the serration 65 has the plurality of sawteeth 65a which are aligned at the predetermined pitches P in the radial direction and which extend in the circumferential direction respectively. The serration 66 has the plurality of sawteeth 66a which are aligned at the predetermined pitches P in the circumferential direction and which extend in the radial direction respectively. Further, the spikes 55a, which are aligned at the pitches P respectively in the length direction and the widthwise direction of the master jaw (corresponding to the radial direction and the circumferential direction of the movable stage respectively), are formed on the serration surface 52a of the master jaw 50. The sawteeth 65a, 66a aligned at the pitches P and the spikes 55a aligned at the pitches P as well are fitted to one another. Therefore, when the soft jaw 60 is arranged on the serration surface 52a of the master jaw 50, the soft jaw 60 can be deviated at every interval of the pitch P in the radial direction and/or the circumferential direction. Accordingly, it is possible to position the soft jaw 60 with ease.

In this situation, the arrangement is made so that the distances L, which are provided between the centers O of the movable stages 14 and the end surfaces 60b disposed on the center sides in the radial directions of the movable stages 14 (hereinafter simply referred to as “radial directions”), of the soft jaws 60 attached to the respective movable stages 14, are smaller than the outer diameter of the workpiece 80 respectively. In other words, the positions of the soft jaws 60 in the radial directions are determined so that the distances between the end surfaces 60b of the soft jaws 60 and the centers O of the movable stages 14 are less than 300 mm, and thus the soft jaws 60 are fixed to the master jaws 50 as described above.

Subsequently, the lathe 100 is driven to rotate the fixed stage 13 (movable stages 14), and the forward ends of the soft jaws 60 are subjected to the cutting processing to form gripping surfaces 69a corresponding to the cylindrical surface having the diameter of 300 mm on the end surfaces 60b of the soft jaws 60. Accordingly, the centers of curvature of the gripping surfaces 69a are completely coincident with the centers of the fixed stage 13 and the movable stages 14, i.e., the axis of rotation of the fixed stage. In other words, the gripping surfaces 69a are subjected to the centering with respect the fixed stage 13 and the movable stages 14.

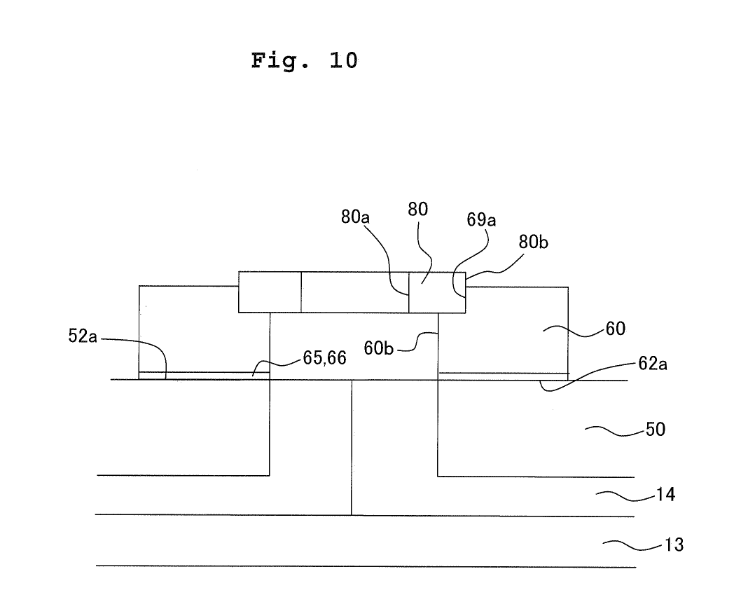

Subsequently, the movable stages 14 are driven outwardly in the radial direction of the fixed stage 13 by means of the unillustrated driving mechanism. The end surfaces 60b (gripping surfaces 69a) of the soft jaws 60 are widened outwardly in the radial direction. Therefore, the workpiece 80 can be arranged at the inside of the end surfaces 60b of the soft jaws 60. After the workpiece 80 is arranged at the center of the movable stages 14, the movable stages 14 are driven inwardly in the radial direction again to grip or clamp the outer cylindrical surface 80b of the workpiece 80 by means of the gripping surfaces 69a of the soft jaws 60 as shown in FIG. 10. In this arrangement, as described above, even when the movable stages 14 are driven inwardly in the radial direction again to return the movable stages 14 to the original positions after the movable stages 14 are driven outwardly in the radial direction, the positions of the movable stages 14 in the radial direction are not deviated. In other words, the centers of curvature of the gripping surfaces 69a are completely coincident with the center O of the movable stages 14 at an accuracy of not more than 1 micron throughout the processes performed before and after the driving operation of the movable stages 14. Therefore, the center of the workpiece 80 gripped by the gripping surfaces 69a can be allowed to coincide with the center O of the movable stages 14 at the accuracy of not more than 1 micron.

After the centering is performed for the workpiece 80 as described above, the lathe 100 is driven to cut and process the inner cylindrical surface 80a of the workpiece 80 while rotating the fixed stage 13 and the movable stages 14 to which the workpiece 80 is fixed.

In such a situation, as described above, the following fear has arisen in the case of the conventional chuck mechanism for the lathe. That is, when the soft jaw is attached to the master jaw again after the soft jaw is detached from the master jaw, the center of curvature of the gripping surface of the soft jaw may be deviated, for example, from the center of the fixed stage. Therefore, it has been hitherto necessary that the centering should be performed every time when the soft jaw is attached to the master jaw. In other words, it has been hitherto necessary that the processing should be performed again for the end surface of the soft jaw to newly form a gripping surface subjected to the centering every time when the soft jaw is attached to the master jaw. Therefore, a problem has hitherto arisen such that the time and labor are consumed for the step of the centering described above every time when the soft jaw is exchanged.

On the contrary, in the case of the chuck mechanism 1 according to the embodiment of the present invention, when the soft jaw 60 is attached to the master jaw 50 again after the soft jaw 60 is detached from the master jaw 50, then the attachment reproducibility is enhanced, and the center of curvature of the gripping surface 69a of the soft jaw 60 is not deviated, for example, from the center O of the fixed stage. Therefore, when the soft jaw 60 is attached to the master jaw 50 again, then it is unnecessary to perform the processing of the end surface of the soft jaw again, and it is possible to greatly mitigate the step of the centering described above. According to the measurement performed by the inventors, it has been revealed that the positional deviation, which is provided between the center of curvature of the gripping surface 69a of the soft jaw 60 and the center O of the fixed stage or the like when the soft jaw 60 is attached to the master jaw 50 again after the soft jaw 60 is once detached from the master jaw 50, is suppressed to be not more than 1 micron. In relation thereto, in the case of the conventional chuck mechanism, the positional deviation was caused in an amount of about 20 microns at the maximum.

The reason, why the attachment reproducibility of the soft jaw 60 can be extremely enhanced in the chuck mechanism 1 according to the present invention, is considered as follows by the inventors. The serrations 65 (the plurality of sawteeth 65a), which extend in the circumferential direction, are formed in the first areas 62b of the serration surface 62a of the soft jaw 60, and the serrations 65 are fitted to the spikes 55a which are formed on the serration surface 52a of the master jaw 50. In this arrangement, as shown in FIG. 8, the inclined surfaces 65c of the respective sawteeth 65b of the serrations 65 and the inclined surfaces 55c of the spikes 55a are subjected to the surface-to-surface contact with each other. Therefore, when the soft jaw 60 is arranged on the master jaw 50, there is no fear of the deviation in the direction (radial direction) perpendicular to the circumferential direction in which the sawteeth 65a are allowed to extend. Therefore, the reproducibility is extremely enhanced for the attachment position in relation to the concerning direction.

Further, the serrations 66 (the plurality of sawteeth 66a), which extend in the radial direction, are formed in the second area 62c of the serration surface 62a of the soft jaw 60, and the serrations 66 are fitted to the spikes 55a which are formed on the serration surface 52a of the master jaw 50. Further, the inclined surfaces 66c of the respective sawteeth 66b of the serrations 66 and the inclined surfaces 55c of the spikes 55a are subjected to the surface-to-surface contact with each other. Therefore, when the soft jaw 60 is arranged on the master jaw 50, there is no fear of the deviation in the direction (circumferential direction) perpendicular to the radial direction in which the sawteeth 66a are allowed to extend. Therefore, the reproducibility is extremely enhanced for the attachment position in relation to the concerning direction as well.

In other words, the plurality of sawteeth 65a, 66a, which extend in the radial direction and the circumferential direction, are formed on the serration surface 62a of the soft jaw 60. The inclined surfaces 65c, 66c of the sawteeth and the inclined surfaces 55c of the spikes 55a formed on the serration surface 52a of the master jaw 50 are fitted to one another in the state of being subjected to the surface-to-surface contact with each other. Therefore, when the soft jaw 60 is arranged on the master jaw 50, there is no fear of the deviation of the soft jaw 60 in any direction of the in-plane directions of the serration surface 52a. Further, the plurality of sawteeth 65a, 66a and the plurality of spikes 55a are fitted to one another, and it is possible to mutually counteract the production error of each of the sawteeth or the spikes. Therefore, it is considered that the influence, which is to be exerted by the production error of the sawteeth or the spikes, can be suppressed as compared with a case in which only one of the sawtooth or the spike is formed.

As described above, the serrations 55 and the serrations 65, 66 are formed on the master jaw 50 and the soft jaw 60 of the chuck mechanism 1 respectively. Accordingly, the reproducibility is secured for the attachment accuracy of the soft jaw 60. However, the chuck mechanism according to the present invention is not limited thereto. For example, it is also allowable to adopt the following forms. The constitutive components or parts, which are the same as or equivalent to those of the chuck mechanism 1 described above, are designated by the same reference numerals, any explanation of which will be appropriately omitted.

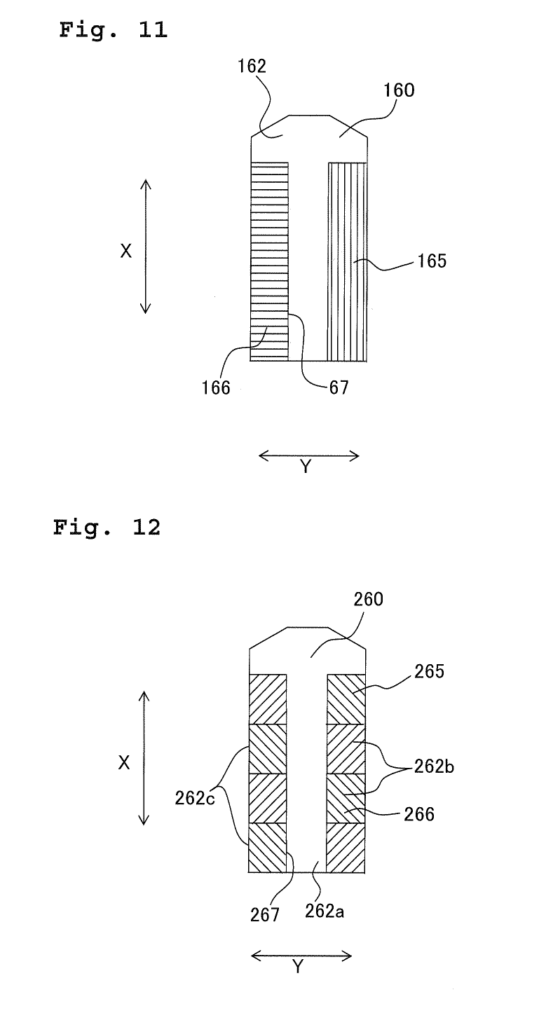

As shown in FIG. 11, serrations 165 which extend in the length direction of a soft jaw 160 and serrations 166 which extend in the widthwise direction may be formed respectively on the both sides of a serration surface 162a of the soft jaw 160 with a groove 67 intervening therebetween. Even in the case of such an arrangement, when the soft jaw is attached to the serration surface of the master jaw described above, the soft jaw is not deviated in the in-plane direction of the serration surface of the master jaw. It is possible to enhance the reproducibility of the attachment accuracy when the soft jaw is attached to the master jaw.

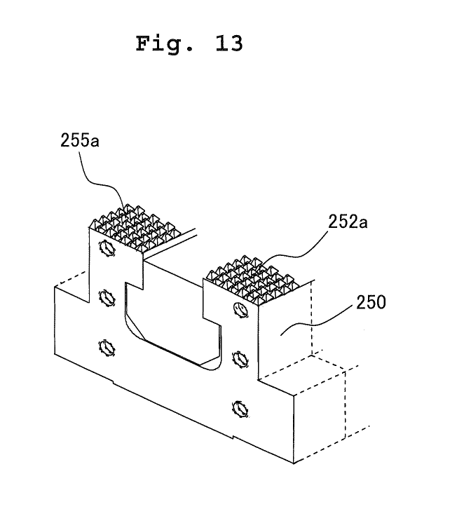

The serrations, which are formed on the serration surface of the soft jaw, are not limited to those extending in the widthwise direction and the length direction of the soft jaw. It is also allowable to form serrations which extend in two directions different from the widthwise direction and the length direction of the soft jaw respectively. A serration surface 262a of a soft jaw 260 shown in FIG. 12 has first areas 262b and second areas 262c each two of which are alternately arranged in the length direction. The respective first areas 262b and the respective second areas 262c range over the both sides with a groove 67 intervening therebetween. Serrations 265, which extend in a direction inclined by 45° toward the groove 67 (toward the center) with respect to the length direction of the soft jaw 260, are formed in the first area 262b. Serrations 266, which extend in a direction inclined by 45° toward the side opposite to the groove 67 (toward the outer side) with respect to the length direction of the soft jaw 260, are formed in the second area 262c.

In this arrangement, as shown in FIG. 13, spikes 255a, which are aligned at predetermined pitches P respectively in a direction inclined by +45° with respect to the length direction of a master jaw 250 and in a direction inclined by −45°, are formed on a serration surface 252a of the master jaw 250 to be fitted to the soft jaw 260. Accordingly, the spikes 255a, which are formed on the serration surface 252a of the master jaw 250, are fitted to the serrations 265, 266 which are formed on the serration surface 262a of the soft jaw 260. Therefore, when the soft jaw is attached to the serration surface of the master jaw, the soft jaw is not deviated in the in-plane direction of the serration surface of the master jaw. It is possible to enhance the reproducibility of the attachment accuracy when the soft jaw is attached to the master jaw.

In the embodiment and the modified embodiments thereof described above, the plurality of spikes are formed on the serration surface of the master jaw, and the serrations having the plurality of stripe-shaped sawteeth are formed on the serration surface of the soft jaw. On the contrary, the plurality of spikes may be formed on the serration surface of the soft jaw, and the serrations having the plurality of stripe-shaped sawteeth may be formed on the serration surface of the master jaw. Alternatively, the serrations having the plurality of sawteeth to be fitted to one another may be formed on the serration surfaces of the master jaw and the soft jaw respectively. In this arrangement, the serrations, which are formed on the master jaw and/or the soft jaw, are not limited to the two types of the sawteeth which are perpendicular to one another. It is enough to include two types of sawteeth which extend in different directions, wherein the angle of intersection of the sawteeth may be arbitrary. For example, it is also allowable to use two types of sawteeth which extend in directions intersecting with each other at 60°. The cross-sectional shapes of the sawteeth or the spikes formed on the master jaw and/or the soft jaw are not limited to the triangular shapes. It is possible to adopt any arbitrary shape provided that the sawteeth or the spikes formed on the master jaw and the sawteeth or the spikes formed on the soft jaw are subjected to the surface-to-surface contact with each other. Further, the pitches are not limited to 3 mm for the sawteeth or the spikes which are formed on the master jaw and/or the soft jaw. The sawteeth or the spikes may be formed at arbitrary pitches including, for example, pitches of 1.5 mm.

In the embodiment described above, for example, the length of the leg of the fixing member is larger than the depth of the upper portion of the groove of the master jaw, and the top surface of the leg protrudes from the serration surface of the master jaw when the fixing member is inserted into the groove of the master jaw. For this reason, the groove, which is provided in order to avoid any abutment against the leg of the fixing member, is formed on the serration surface of the soft jaw. However, the length of the leg of the fixing member may be shorter than the depth of the groove of the master jaw. In other words, it is also allowable that the top surface of the fixing member is lower than the serration surface of the master jaw when the fixing member is inserted into the groove of the master jaw. There is no fear of the deviation of the position of the soft jaw in the in-plane direction of the serration surface as described above irrelevant to whether or not the leg of the fixing member and the groove formed for the soft jaw are fitted to one another.

In the embodiment described above, for example, the sizes, the materials, the shapes, and the arrangement of the master jaw and the soft jaw can be arbitrarily established in conformity with the shape and the material of the workpiece. For example, even when the workpiece is polygonal prism-shaped without having the substantially cylindrical or annular shape, the chuck mechanism can be utilized as the chuck mechanism of the present invention by adapting the shape of the soft jaw to the shape of the workpiece. Further, the foregoing embodiment has been explained as exemplified by the case in which the workpiece is gripped from the outer side thereof by way of example. However, the chuck mechanism of the present invention can be also used when the workpiece 80 is gripped from the inner side thereof.

In the embodiment described above, the master jaw of the chuck mechanism is fixed on the movable stage which is movable in the radial direction of the fixed stage. However, the master jaw may be provided movably in the radial direction of the fixed stage by means of a driving mechanism based on the use of, for example, the air or the hydraulic pressure. It is not necessarily indispensable to provide the fixing member. The soft jaw may be directly fixed to the master jaw by means of a bolt or the like, for example, such that a screw hole is formed for the master jaw. When the fixing member is used, for example, the shape of the fixing member is not limited to the shape described in the foregoing embodiment. The shape of the fixing member can be designed to provide any arbitrary shape.

In the lathe of the embodiment described above, the workpiece is fixed by means of the three soft jaws. However, the workpiece may be fixed by means of four or more soft jaws. In the embodiment described above, the forward ends of the sawteeth of the serrations and the forward end of the spikes of the master jaw and/or the soft jaw are chamfered. However, it is not necessarily indispensable that the forward ends should be chamfered. The embodiment described above is illustrative of the exemplary case in which the spikes are formed on the master jaw, and the serrations are formed on the soft jaw. On the contrary, the spikes may be formed on the soft jaw, and the serrations may be formed on the master jaw.

In the embodiment described above, the chuck mechanism is attached to the lathe as the machine tool. However, the machine tool, which is provided with the chuck mechanism of the present invention, is not limited to the lathe. In the lathe of the embodiment described above, the workpiece, which is fixed to the chuck mechanism, is processed while rotating the workpiece at a high speed. However, there is no limitation thereto. The chuck mechanism of the present invention can be also used for a machine tool in which a workpiece is processed by using a blade or edge which is moved at a high speed in a state in which the workpiece is fixed to the chuck mechanism, for example, as in a milling machine and a machining center. It is not necessarily indispensable that the stage, which is used for the lathe or the like, should be provided with the fixed stage and the movable stage. For example, it is also allowable that the stage has only the fixed stage.

### INDUSTRIAL APPLICABILITY

When the chuck mechanism of the present invention is used, even when the chuck mechanism is used while making the exchange into various types of soft jaws depending on the types of workpieces to be processed, then it is unnecessary to process the forward ends of the soft jaws in order to perform the centering of the workpiece every time when the soft jaws are exchanged. It is possible to greatly save the time and labor for the exchange of the soft jaws.

Further, when a plurality of machine tools are equipped with the master jaws concerning the chuck mechanism of the present invention, a set of the soft jaws, which are fitted to the master jaws, can be commonly used for the plurality of machine tools. In this case, the serrations of the master jaws are previously allowed to have the identical shapes, and the master jaws are attached beforehand so that the positions of the serrations of the master jaws are identical in relation to any one of the machine tools. For example, when the master jaws are attached to a rotary stage, the master jaws are previously arranged accurately so that the positions of the serrations of the master jaws from the axis of rotation are identical in relation to any one of the machine tools. In this case, for example, when a certain workpiece is processed by using a plurality of machine tools, a set of the soft jaws, which are provided to grip the workpiece, can be commonly used for the plurality of machine tools. In this case, even when the set of the soft jaws are attached to the master jaws of any one of the machine tools, the set of the soft jaws can be attached reproducibly at a sufficient positional accuracy.

As described above, when the chuck mechanism of the present invention is used, it is possible to construct a machine tool system in which a set of the soft jaws can be commonly attached to a plurality of machine tools. Further, even when the set of the soft jaws are attached to the master jaws of any one of the machine tools, the set of the soft jaws can be attached reproducibly at a sufficient positional accuracy. Therefore, when the soft jaws are attached to each of the machine tools, it is possible to greatly save the time and labor for the attachment and the positional adjustment of the soft jaws.

1. A chuck mechanism which grips a workpiece, comprising:
a stage which is rotatable about a center of a predetermined axis of rotation;
a plurality of master jaws which are provided on the stage, the master jaws being movable in directions directed toward the axis of rotation of the stage and each of the master jaws having a master side serration surface formed with a plurality of first serrations extending in a first direction and a plurality of second serrations extending in a second direction different from the first direction; and
a plurality of soft jaws which are fixed to the master side serration surfaces of the master jaws to grip the workpiece, respectively, each of the soft jaws having a soft side serration surface arranged to face the master side serration surface and formed with third serrations and fourth serrations, the third serrations extending in the first direction to be fitted to the first serrations, and the fourth serrations extending in the second direction to be fitted to the second serrations.

2. The chuck mechanism according to claim 1, wherein the first direction is perpendicular to the second direction.

3. The chuck mechanism according to claim 1, wherein the soft side serration surface of each of the soft jaws has a first area in which the third serrations are formed and a second area which is formed to be independent from the first area and in which the fourth serrations are formed.

4. The chuck mechanism according to claim 3, wherein the first serrations and the second serrations are formed in a same area on the master side serration surface of each of the master jaws.

5. The chuck mechanism according to claim 1, wherein a plurality of substantially quadrangular pyramid-shaped spikes, which are arranged in a lattice form in the first direction and the second direction respectively and which have chamfered forward ends, are formed on the master side serration surface of each of the master jaws.

6. The chuck mechanism according to claim 1, wherein the third and fourth serrations, which are formed on the soft side serration surface of the soft jaw, are a plurality of stripe-shaped sawteeth which have substantially triangular cross sections and which have chamfered forward ends.

7. The chuck mechanism according to claim 1, wherein the stage has a fixed stage which is substantially circular, and a plurality of movable stages which are provided movably in a radial direction of the fixed stage and which are formed with a plurality of grooves into which the master jaws are to be inserted; and
the plurality of master jaws are fixed to inner portions of the grooves of the movable stages respectively.

8. The chuck mechanism according to claim 1, further comprising a plurality of connecting members which connect the master jaws and the soft jaws respectively, wherein grooves into which the connecting members are to be inserted are formed for the respective master jaws.

9. The chuck mechanism according to claim 8, wherein the connecting member has a substantially T-shaped cross-sectional shape, and includes a head which is plate-shaped and a leg which has a width narrower than that of the head and which is allowed to extend perpendicularly to an in-plane direction of the head; and
the groove, which is formed in the master jaw, has a substantially T-shaped cross-sectional shape formed with a bottom portion which has a width wider than the width of the head and an upper portion which has a width narrower than the width of the head and wider than the width of the leg.

10. The chuck mechanism according to claim 9, wherein a groove, which is to be fitted to the leg of the connecting member, is formed on the soft side serration surface of each of the soft jaws.

11. The chuck mechanism according to claim 8, wherein a length, of the connecting members, in a depth direction of the grooves is shorter than a depth of the grooves.

12. A lathe comprising the chuck mechanism as defined in claim 1.

13. A jaw member usable for a chuck mechanism which grips a workpiece, the jaw member comprising:
a plurality of master jaws each of which has a master side serration surface formed with a plurality of first serrations extending in a first direction and a plurality of second serrations extending in a second direction different from the first direction; and
a plurality of soft jaws which are fixed to the master side serration surfaces of the master jaws respectively to grip the workpiece, each of the soft jaws having a soft side serration surface arranged to face the master side serration surface and formed with third serrations and fourth serrations, the third serrations extending in the first direction to be fitted to the first serrations, and the fourth serrations extending in the second direction to be fitted to the second serrations.

14. The jaw member according to claim 13, wherein the first direction is perpendicular to the second direction.

15. The jaw member according to claim 13, wherein the first and second serrations, which are formed on the master side serration surface of each of the master jaws, include a plurality of substantially quadrangular pyramid-shaped spikes which are arranged in a lattice form in the first direction and the second direction respectively and which have chamfered forward ends; and
the third and fourth serrations, which are formed on the soft side serration surface of the soft jaw, are a plurality of stripe-shaped sawteeth which have substantially triangular cross sections and which have chamfered forward ends.
